(19) United States
(12) Patent Application Publication
(10) Pub. No.: US 2006/0158579 A1
(43) Pub. Date: Jul. 20, 2006

(54) Liquid-crystal display device

(75) Inventor: Fumio Hasegawa, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kanagawa (JP)

(21) Appl. No.: 11/333,252

(22) Filed: Jan. 18, 2006

(30) Foreign Application Priority Data
Jan. 19, 2005 (JP) 011571/2005

(51) Int. Cl. G02F 1/1333

(52) U.S. Cl. 349/58

(57) ABSTRACT

An LCD device suppresses the display quality degradation due to the mechanical strain of an LCD panel, the optical leakage through the gap between the frame-like portion of the casing (the shield front) and the panel, and the dust penetrated through the gap. The window of the casing or shield front is formed to be larger than an outer dimension of the second substrate. A sheet having electrical conductivity and a light-blocking property is placed in an approximately entire region sandwiched by an outer portion of the second substrate and a frame-like portion of the casing that surrounds the window. An electrically conductive layer is formed directly on or indirectly by way of an optical member on a surface of the second substrate, the surface being located on a side of the window. The sheet is connected to an inner surface of the frame-like portion of the casing and to the layer at the outer portion of the second substrate or on the member.

### BACKGROUND OF THE INVENTION

1. Field of the Invention

The present invention relates to a Liquid-Crystal Display (LCD) device. The invention is applicable to any other device or apparatus than the LCD device if it has a structure that components or members are received or enclosed in a frame-shaped casing, for example, a display device employing an organic EL (ElectroLuminescence) element.

2. Description of the Related Art

There have been strong demands on weight reduction, thinning, and picture-frame-narrowing for the LCD device. To meet such the demands, the use of material and/or structure having higher rigidity has been examined in structural design. The casing for receiving the LCD panel, which is usually called the “shield front”, is one of the structural members of the LCD device. The casing has various functions of increasing the rigidity of the LCD device; protecting the LCD panel, the tape carrier package (TCP) mounted near the panel, and the electronic circuit board; preventing the electrification of the panel; and blocking the unwanted optical leakage by way of the periphery of the panel.

Recently, active-matrix addressing is mainly used as the method of displaying images on the LCD device, which is divided into two displaying types using vertical electric-field and lateral electric-field. These two displaying types are different in the electrode structure for applying the electric field to the liquid-crystal composite. The type using lateral electric-field, which is termed the “In-Plane Switching (IPS)” type, has an advantage that the viewing angle characteristics are improved. This is because the transmittance of the liquid-crystal composite is controlled by changing the orientation of the liquid-crystal molecules in planes parallel to the LCD panel.

However, the IPS-type LCD device has a disadvantage that the screen of the device is likely to be seen white due to unwanted penetration of light induced by mechanical distortion or deformation of the LCD panel. The reason of this disadvantage is that mechanical distortion or deformation of the panel causes unwanted change of the orientation of the liquid-crystal molecules and therefore, the control of light is disturbed and unwanted penetration of light will occur. Taking these facts into consideration, conventionally, as shown in FIG. 1, it has been necessary in designing the IPS-type LCD device to increase the gap between an LCD panel 101 and a shield front (i.e., a casing) 102, thereby avoiding the contact of the front 102 with the panel 101. The reference numerals 101a, 101b, 101c, 101d, and 101e in FIG. 1 denote a first transparent substrate, a second transparent substrate, a first polarizing sheet, a second polarizing sheet, and a conductive layer of the panel 101, respectively. This conventional structure is disclosed in, for example, the Japanese Non-Examined Patent Publication No. 2002-174811 published in 2002, in particular, on Pages 3 to 5 and FIG. 1 thereof.

Moreover, with the IPS-type LCD device, electric field needs to be laterally applied to the liquid-crystal composite. However, if the surface of the LCD panel is electrified, electric field tends to be vertically applied to the same composite. In this case, the orientation of the liquid-crystal molecules is distorted and the control of light is disturbed and therefore, unwanted penetration of light will occur. As a result, the screen of the device is likely to be seen white. Accordingly, to release the electric charges induced by the electrification of the LCD panel, for example, the following measure has been generally taken.

Specifically, as shown in FIG. 1, the conductive layer 101e is formed on the surface of the second transparent substrate 101b of the panel 101. One end of the conductive spring 105 is fixed to the shield front 102. The other end of the spring 105 is contacted with the conductive layer 101e. Thus, the surface of the second substrate 101b and the front 102 are electrically continuous to each other, thereby releasing the electric charges onto the surface of the panel 101 to the ground.

The conventional shield front (i.e., casing) 102 is made of metallic material such as stainless steel or aluminum. However, the weight of a large-sized LCD device of 15-inch or greater exceeds 1 kg and the dimension thereof is considerably large. Thus, the front 102 needs to have a sufficiently high rigidity. To accomplish the need on rigidity, usually, an aluminum plate with a thickness of approximately 1 mm or a stainless steel plate with a thickness of approximately 0.5 mm is subjected to a drawing process with a pressing machine, thereby forming a united structure whose corner portions, side portions, and upper portion (i.e., light-shielding portion) of the front 102 are formed continuously. In this case, however, the elongation of the material used is not uniform in the light-shielding portion and the corner portions of the front 102 and therefore, strain is generated in the material. Due to the dispersion of the strain in the material, considerable large deformation (e.g., approximately 1 mm in waviness) occurs in the picture-frame area (i.e., the light-shielding portion) of the front 102. Accordingly, to ensure the non-contact of the front 102 with the panel 101, it is necessary for the gap between the front 102 and the panel 101 to be greater than the processing accuracy of the flatness of the front 102. This means that there arises a disadvantage of an increased thickness of the LCD device.

To prevent the above-described disadvantage relating an increased thickness of the device, conventionally, it is typical that the side portions of the front 102 are formed by bending the aluminum or stainless steel plate. Due to the use of bending, elongation and shrinkage of the material of the plate is reduced and therefore, the processing accuracy of the flatness of the front 102 can be improved to the level that the waviness is approximately 0.4 mm at the maximum in the picture-frame area of the upper portion of the front 102. However, the use of bending necessitates slits in the corner portions of the front 102. This means that the side portions of the front 102 are separated from each other by the slits, in other words, they are supported by its upper portion only. As a result, the rigidity of the front 102 is reduced to an extremely low value and thus, there arises a disadvantage that torsion deformation is likely to occur in the vicinities of the respective corners of the front 102. Accordingly, the gap between the light-shielding portion of the front 102 and the panel 101 needs to be determined while taking the dimensional dispersion or non-uniformity induced by the above-described torsion deformation into consideration. If the gap between the light-shielding portion of the front 102 and the panel 101 is too large, there is a disadvantage that the LCD device is too thick. To avoid the excessive increase of the said gap by decreasing the said torsion deformation, there is a disadvantage that an amending or adjusting process needs to be carried out after the bending process.

As explained above, to prevent the display quality degradation of the LCD panel 102 caused by the above-identified mechanical strains in the shield front 102, the inner end of the picture-frame area of the front 102 (i.e., the peripheral area of the rectangular window of the front 102) needs to be separated from the panel 101. However, if the gap between the picture-frame area of the front 102 and the panel 101 is too large, the thickness of the LCD device will be too large. Therefore, the picture-frame area of the front 102 will necessitate high processing accuracy of the flatness and as a result, there arises a problem that the processing cost of the front 102 is increased.

Moreover, the shield front 102 needs to have a function of blocking the unwanted optical leakage by way of the periphery of the panel 101 and a function of preventing the penetration of dust through the gap between the front 102 and the panel 101. Therefore, as shown in FIG. 1, the window of the front 102 is formed to be smaller than the outer dimensions (i.e., the contour) of the second substrate 101b. Even if the dimension of the window of the front 102 is decreased, the gap needs to be formed between the picture-frame area of the front 102 and the panel 101. As a result, there arises problems that the display quality is lowered by the optical leakage by way of the gap, that display malfunction occurs due to the shade of dust penetrated through the gap, and/or that electrical short-circuit in inner circuitry is induced by conductive dust penetrated through the gap.

### SUMMARY OF THE INVENTION

The present invention was created in consideration of the above-described problems.

A main object of the present invention is to provide an LCD device that suppresses the display quality degradation due to the mechanical strain of the LCD panel, the optical leakage through the gap between the frame-like portion of the casing (i.e., the shield front) and the panel, and the dust penetrated through the gap.

The above object together with others not specifically mentioned will become clear to those skilled in the art from the following description.

According to a first aspect of the present invention, an LCD device is provided, which comprises an LCD panel having a first transparent substrate, a second transparent substrate, and a liquid-crystal composite sandwiched by the first and second substrates; and a casing for receiving the panel, the casing having a window on a side of the second substrate. The window of the casing is formed to be larger than an outer dimension of the second substrate. A sheet having electrical conductivity and a light-blocking property is placed in an approximately entire region sandwiched by an outer portion of the second substrate and a frame-like portion of the casing that surrounds the window. An electrically conductive layer is formed directly on or indirectly by way of an optical member on a surface of the second substrate, the surface being located on a side of the window. The sheet is connected to an inner surface of the frame-like portion of the casing and to the layer at the outer portion of the second substrate or on the member.

With the LCD device according to the first aspect of the present invention, the window of the casing is formed to be larger than an outer dimension of the second substrate and therefore, the casing will not contact directly the second substrate even if the processing accuracy of the flatness of the casing is lowered. Only the sheet having electrical conductivity and a light-blocking property is connected to an inner surface of the frame-like portion of the casing and to the layer at the outer portion of the second substrate or on the member. Therefore, strain to be caused in the LCD panel is restrained to a sufficiently low level and at the same time, the orientation disorder of the molecules of the liquid-crystal composite is restrained in a permissible range. Accordingly, the display quality degradation due to the mechanical strain of the LCD panel can be suppressed.

Moreover, a sheet having electrical conductivity and a light-blocking property is placed in an approximately entire region sandwiched by an outer portion of the second substrate and a frame-like portion of the casing that surrounds the window. An electrically conductive layer is formed directly on or indirectly by way of an optical member on a surface of the second substrate, the surface being located on a side of the window. The sheet is connected to an inner surface of the frame-like portion of the casing and to the layer at the outer portion of the second substrate or on the member. Therefore, electric charges induced by electrification of the surface of the panel are released to the casing by way of the sheet, leakage light generated by diffused reflection in the periphery of the panel is surely blocked, and dust is surely prevented from entering the inside of the casing through the gap between the casing and the panel.

In a preferred embodiment of the LCD device according to the first aspect of the present invention, the sheet has a cross-section with at least one bend. When the LCD device is placed in such a way that the window of the casing is located at a top position, a first part of the sheet on the frame-like portion of the casing is lower than a second part of the sheet on the outer portion of the second substrate or on the member. The inner surface of the frame-like portion of the casing is approximately equal to or lower than in height a surface of the second substrate or the member on the side of the window.

In another preferred embodiment of the LCD device according to the first aspect of the present invention, the sheet is connected to the frame-like portion of the casing with an electrically conductive fixing member.

In still another preferred embodiment of the LCD device according to the first aspect of the present invention, an end portion of the sheet on a side of the casing is bent toward the frame-like portion of the casing. The sheet is fixed to the frame-like portion with a fixing member. The sheet is contacted with the frame-like portion at the end portion.

It is preferred that the sheet has a picture-frame-shaped contour. Alternately, the sheet is preferably formed by a combination of L-shaped, U-shaped, or I-shaped (i.e., linear) parts.

It is preferred that the sheet is made of polyethylene telephthalate (PET) resin, nylon resin, or vinyl chloride resin, into which an electrically conductive material or ingredient is mixed. Alternately, the sheet is preferably made of stainless steel.

According to a second aspect of the present invention, another LCD device is provided, which comprises an LCD panel having a first transparent substrate, a second transparent substrate, and a liquid-crystal composite sandwiched by the first and second substrates, and a casing for receiving the panel, the casing having a window on a side of the second substrate. The window of the casing is formed to be larger than an outer dimension of the second substrate. A sheet having electrical conductivity and a light-blocking property is placed in an approximately entire region sandwiched by an outer portion of the second substrate and a frame-like portion of the casing that surrounds the window. An electrically conductive layer is formed directly on or indirectly by way of an optical member on a surface of the second substrate, the surface being located on a side of the window. The sheet is connected to an outer surface of the frame-like portion of the casing and to the layer at the outer portion of the second substrate or on the member.

The device according to the second aspect is different from the above-described LCD device according to the first aspect in that the sheet having electrical conductivity and a light-blocking property is connected to an “outer surface” of the frame-like portion of the casing. The other configurations of these devices are the same. Therefore, because of the same reason as shown for the device of the first aspect, the device of the second aspect has the same advantages as those of the device of the first aspect.

In a preferred embodiment of the LCD device according to the second aspect of the present invention, when the LCD device is placed in such a way that the window of the casing is located at a top position, the outer surface of the frame-like portion of the casing is lower in height than a surface of the second substrate or the member on the side of the window.

In another preferred embodiment of the LCD device according to the second aspect of the present invention, the sheet is connected to the frame-like portion of the casing with an electrically conductive fixing member.

In still another preferred embodiment of the LCD device according to the second aspect of the present invention, an end portion of the sheet on a side of the casing is bent toward the frame-like portion of the casing. The sheet is fixed to the frame-like portion with a fixing member. The sheet is contacted with the frame-like portion at the end portion.

It is preferred that the sheet has a picture-frame-shaped contour. Alternately, the sheet is preferably formed by a combination of L-shaped, U-shaped, or I-shaped (i.e., linear) parts.

It is preferred that the sheet is made of polyethylene telephthalate (PET) resin, nylon resin, or vinyl chloride resin, into which an electrically conductive material or ingredient is mixed. Alternately, the sheet is preferably made of stainless steel.

### BRIEF DESCRIPTION OF THE DRAWINGS

In order that the present invention may be readily carried into effect, it will now be described with reference to the accompanying drawings.

FIG. 1 is a schematic cross-sectional view showing the detailed structure of a conventional LCD device.

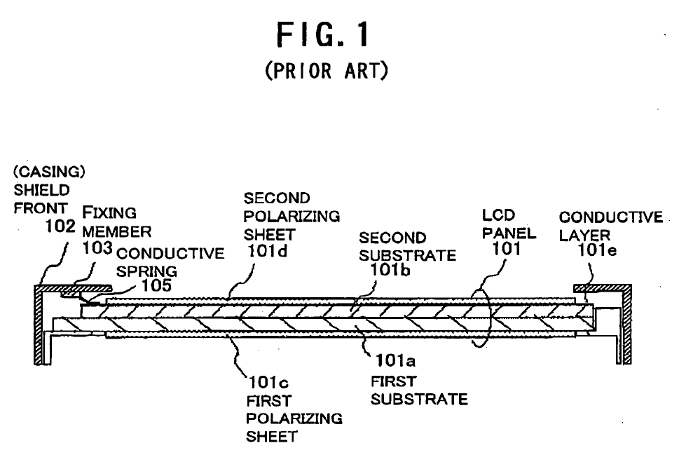

FIG. 2 is a schematic perspective view of an LCD device according to a first embodiment of the invention seen from the display screen side, which shows the whole structure of the device.

FIG. 3 is a schematic cross-sectional view along the line III-III, which shows the detailed structure of the LCD device according to the first embodiment of FIG. 2.

FIGS. 4A to 4C are schematic plan views showing the plan shape of the sheet having electrical conductivity and a light-blocking property, respectively, each of which is alternatively used in the LCD device according to the first embodiment of FIG. 2.

FIG. 5 is an enlarged, partial, schematic cross-sectional view along the line III-III in FIG. 2, which shows the detailed structure of an LCD device according to a second embodiment of the invention.

FIG. 6 is an enlarged, partial, schematic cross-sectional view along the line III-III in FIG. 2, which shows the detailed structure of an LCD device according to a third embodiment of the invention.

FIG. 7 is a schematic cross-sectional view along the line III-III in FIG. 2, which shows the detailed structure of an LCD device according to a fourth embodiment of the invention.

FIGS. 8A and 8B are schematic plan views showing the plan shape of the sheet having electrical conductivity and a light-blocking property, respectively, each of which is alternatively used in the LCD device according to the first embodiment of FIG. 2.

FIG. 9 is an enlarged, partial, schematic cross-sectional view along the line III-III in FIG. 2, which shows the detailed structure of an LCD device according to a fifth embodiment of the invention.

### DETAILED DESCRIPTION OF THE PREFERRED EMBODIMENTS

Preferred embodiments of the present invention will be described in detail below while referring to the drawings attached.

As explained in the BACKGROUND OF THE INVENTION, the IPS-type LCD device has a problem that the screen of the device is likely to be seen white due to unwanted penetration of light induced by mechanical distortion or deformation of the LCD panel. The reason of this problem is that mechanical distortion or deformation of the panel causes unwanted change of the orientation of the liquid-crystal molecules and therefore, the control of light is disturbed and unwanted penetration of light will occur. Therefore, when designing the IPS-type LCD device, it is necessary to take the processing accuracy of the flatness of the casing into consideration. To reduce the thickness of the device, the processing accuracy of the flatness of the casing needs to be improved or raised.

Moreover, with the IPS-type LCD device, electric field needs to be laterally applied to the liquid-crystal composite. However, if the surface of the LCD panel is electrified, electric field tends to be vertically applied to the same composite. In this case, the orientation of the liquid-crystal molecules is distorted and the control of light is disturbed and therefore, unwanted penetration of light will occur. As a result, there arises a problem that the screen of the device is likely to be seen white. Accordingly, it is necessary to take a measure for releasing the electric charges induced by the electrification of the LCD panel.

In addition, leakage light generated by diffused reflection in the periphery of the LCD panel needs to be blocked, and outside dust needs to be prevented from entering the inside of the casing.

With the present invention, to solve above-described problems and to meet the above-described needs, the window of the casing is formed to be larger than the outer dimension of the second transparent substrate. This is to eliminate the possibility that the casing contacts the second substrate directly, thereby making a high processing accuracy of flatness of the casing unnecessary.

At the same time, a sheet having electrical conductivity and a light-blocking property is placed in an approximately entire region sandwiched by an outer portion of the second substrate and a frame-like portion of the casing that surrounds the window. This is to reduce the mechanical strain to be caused in the LCD panel with the use of the sheet.

Moreover, electric charges induced by electrification of the surface of the panel are released to the casing by way of the sheet. Leakage light generated by diffused reflection in the periphery of the panel is surely blocked by the sheet. Outside dust is surely prevented from entering the inside of the casing by the sheet.

Because of these advantages of the invention, the display quality of the LCD device is effectively improved.

Preferred embodiments of the present invention will be explained below in more detail with reference to the drawings attached.

### First Embodiment

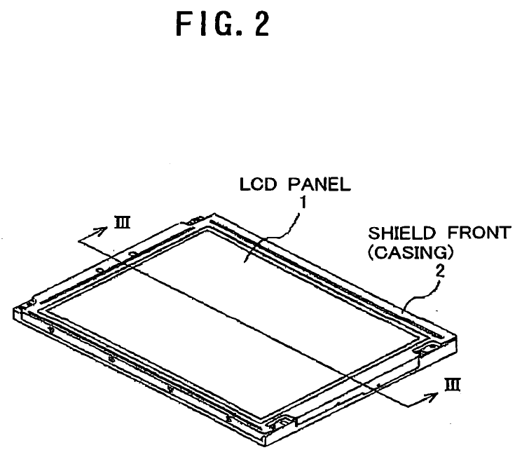

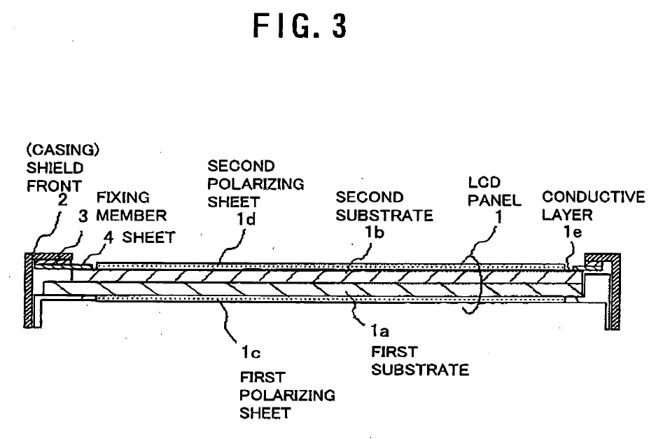

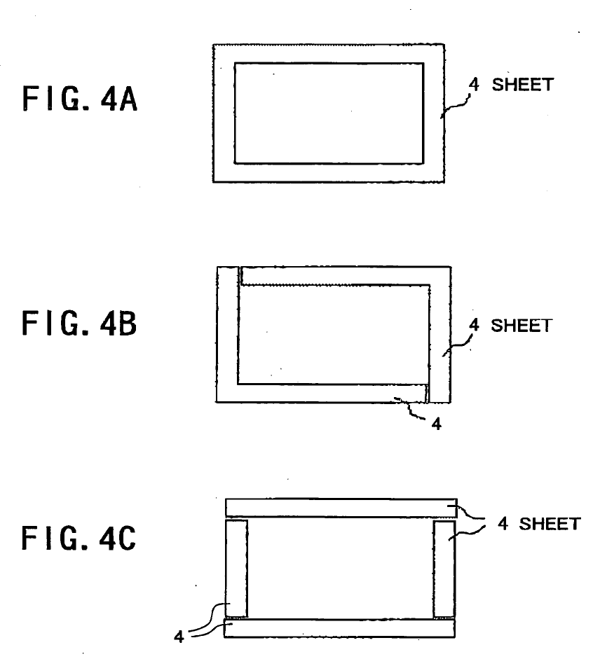

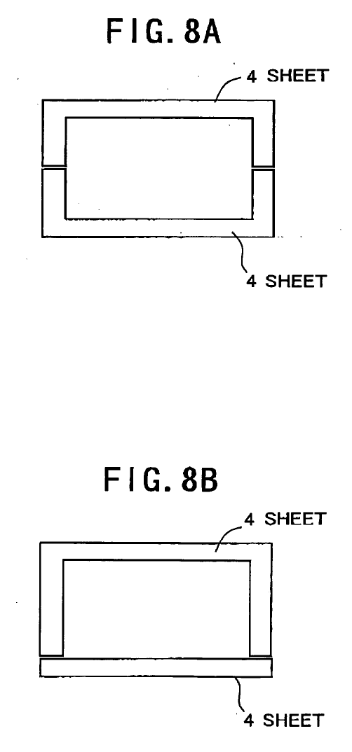

An LCD device according to a first embodiment of the invention will be explained with reference to FIGS. 2 to 4. FIG. 2 shows the whole structure of the device, FIG. 3 shows the detailed structure thereof, and FIGS. 4A to 4C and FIGS. 8A and 8B show variations of a sheet having electrical conductivity and a light-blocking property used in this device.

As shown in FIG. 2, the LCD device according to the first embodiment comprises as its main components an LCD panel 1, a backlight unit (not shown) for generating backlight illuminating the panel 1, and a casing or shield front 2 for receiving the panel 1. As shown in FIG. 3, the panel 1 comprises a first transparent substrate 1a, a second transparent substrate 1b, optical members fixed on the surface of the first substrate 1a, and optical members fixed on the surface of the second substrate 1b. An electrically conductive layer 1e, which is made of Indium Tin Oxide (ITO) or the like, is formed on the surface of the second substrate 1b.

Switching elements such as Thin-Film Transistors (TFTs) (not shown) are formed on the first substrate 1a for the respective pixels arranged in a matrix array. Other necessary elements (not shown) are formed on the first substrate 1a.

A color filter, a black matrix and other necessary elements (all of which are not shown) are formed on the second substrate 1b.

As the optical members on the first substrate 1a, for example, a polarizing sheet and a phase difference sheet are used. Only a first polarizing sheet 1c as an example of these members is shown in FIG. 3. The sheet 1c is adhered onto the surface of the first substrate 1a.

As the optical members on the second substrate 1b, for example, a polarizing sheet and a phase difference sheet are used. Only a second polarizing sheet 1d as an example of these members is shown in FIG. 3. The sheet 1d is adhered onto the surface of the second substrate 1b.

The features of the invention exist in the structure of the casing or shield front 2 and the structure of the sheet 4. Therefore, the structure, shape, and material of the other structural members are not limited to the ones shown here. Any other modification may be possible for these members. For example, the electrically conductive layer 1e may be formed on the surface of the second polarizing sheet 1d or other optical member.

The shield front or casing 2 has an inverted L-shaped cross section and a rectangular window or opening in its central area. The front 2 is made of a metallic material, which is formed by applying a bending or drawing process to a metallic plate with a pressing machine.

With the above-described conventional LCD device, the window of the shield front 102 is formed to be smaller than the outer dimension of the second transparent substrate 101b to prevent the optical leakage and the dust entering. Therefore, if the processing accuracy of flatness of the front 102 is lowered, the front 102 is likely to contact directly the second substrate 101b. To eliminate this possibility, it is necessary to form a gap between the front 102 and the second substrate 101b. In this case, there arises a problem that the thickness of the LCD device is increased and a high processing accuracy of flatness of the front 102 is needed.

Unlike this, with the LCD device according to the first embodiment, the optical leakage and dust entering is prevented by a sheet 4 explained later and therefore, the window of the front 2 can be formed larger than the second substrate 1b. For this reason, there is no possibility that the front 2 contacts the second substrate 1b. Thus, even if mechanical strain is caused in the panel 1, display quality degradation due to the orientation disturbance of the liquid-crystal molecules is suppressed. Moreover, since higher processing accuracy of flatness of the front 2 is unnecessary, fabrication cost can be lowered. In addition, it is sufficient for the invention that the dimension of the window of the front 2 is larger than the outer dimension (i.e., the contour) of the second substrate 1b. However, it is preferred that the window of the front 2 is larger than the contour of the second substrate 1b by approximately 1 mm to 3 mm.

A sheet 4 having electrical conductivity and a light-blocking property is adhered with a fixing member 3 on the inner surface of the frame-like portion, which surrounds the window, of the front 2. The member 3 has electrical conductivity. Here, the member 3 is formed by a piece of a double-sided adhesive tape. The sheet 4 protrudes inwardly to the window of the front 2. The sheet 4 covers the outer portion or peripheral area of the second substrate 1b and contacts the same. An approximately entire region sandwiched by the outer portion of the second substrate 1b and the frame-like portion of the front 2 is covered with the sheet 4.

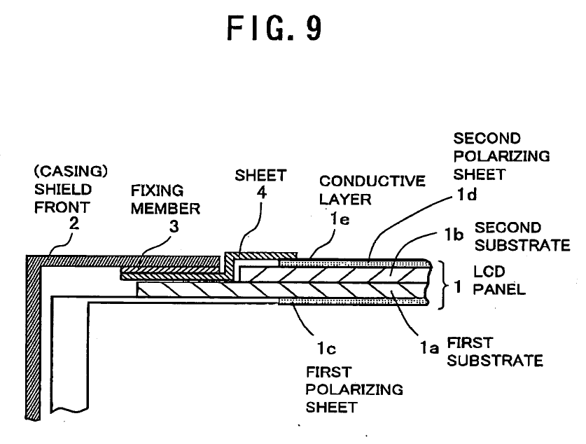

If the conductive layer 1e is formed on the surface of the second polarizing sheet 1d, the sheet 4 is adhered to cover the outer portion or peripheral area of the second polarizing sheet 1d and contacts the same. This will be explained later with reference to FIG. 9.

The material of the fixing member 3 is not limited to the piece of a double-sided tape shown here. The member 3 may be made of any other material if it connects mechanically and electrically the sheet 4 to the front 2. For example, the member 3 may be made of an electrically conductive adhesive.

Any material such as resin, rubber, metal or the like may be used for the sheet 4 if it has electrical conductivity and a light-blocking property. However, the sheet 4 needs to be assembled or fixed in such a way as to contact the second substrate 1b or the second polarizing sheet 1d. If the sheet 4 has an excessive thickness and rigidity, there is a possibility that mechanical strain occurs in the panel 1 due to the sheet 4. Therefore, when resin is used, it is preferred that the sheet 4 is made of polyethylene telephthalate (PET) resin, nylon resin, or vinyl chloride resin as the matrix or base, into which an electrically conductive material or ingredient is mixed. Preferably, the thickness of the sheet 4 is set in the range from approximately 0.05 mm to approximately 0.3 mm.

On the other hand, when metal is used, the rigidity of metal is greater than that of resin and thus, large mechanical strain is likely to occur in the panel 1 due to the sheet 4. Therefore, the thickness of the sheet 4 needs to be smaller. In addition, aluminum and copper have less springiness and as a result, plastic deformation will occur by application of an external force. Accordingly, it is preferred that the sheet 4 is made of stainless steel. Taking the mechanical strain in the panel 1 into the consideration, it is preferred that the thickness of the stainless steel sheet 4 is set at 0.1 mm or less.

It is sufficient for the invention that the sheet 4 covers the approximately whole region between the frame-shaped portion of the front 2 and the second substrate 1b and thus, the shape of the sheet 4 is not limited. For example, as shown in FIG. 4A, the sheet 4 may be picture-frame-shaped. In this case, the possible count of the sheets 4 derived from one original sheet material is lowered and the cost for the material is raised. However, there is an additional advantage that the adhesion process of each sheet 4 on the front 2 can be finished by only one adhering operation. In addition, since relative positional alignment between the sheet 4 and the front 2 is kept unchanged, there is another additional advantage that the adhesion process can be conducted at high positional accuracy.

The sheet 4 may be formed by a combination of two L-shaped parts, as shown in FIG. 4B. In this case, the possible count of the sheets 4 derived from one original sheet material is increased and the cost for the material is reduced, although the count of the adhering operations increases.

The sheet 4 may be formed by a combination of four I-shaped (i.e., rectangular) parts, as shown in FIG. 4C. In this case, the possible count of the sheets 4 derived from one original sheet material is maximized and the cost for the material is further reduced, although the count of the adhering operations increases furthermore. If the material cost is high, this case is beneficial.

The formation of the sheet 4 is not limited to the cases shown in FIGS. 4A to 4C. For example, a combination of a L-shaped part and two I-shaped parts or a combination of a U-shaped part and an I-shaped part may be used for this purpose. A combination of two U-shaped parts is shown in FIG. 8A. A combination of a U-shaped part and an I-shaped part is shown in FIG. 8B.

If optical leakage and dust entering is prevented by any other structural member, it is not necessary that the sheet 4 covers the approximately whole region between the front 2 and the second substrate 1b.

With the LCD device according to the first embodiment of the present invention, as explained above, the window of the shield front or casing 2 is formed to be larger than the outer dimension of the second substrate 1b and therefore, the front 2 will not contact directly the second substrate 1b even if the processing accuracy of the flatness of the front 2 is lowered. Only the sheet 4 having electrical conductivity and a light-blocking property is connected to the inner surface of the frame-like portion of the front 2 and to the conductive layer 1e at the outer portion of the second substrate 1b. Therefore, strain to be caused in the LCD panel 1 is restrained to a sufficiently low level and at the same time, the orientation disorder of the molecules of the liquid-crystal composite is restrained in a permissible range. Accordingly, the display quality degradation due to the mechanical strain of the panel 1 can be suppressed.

Moreover, the sheet 4 having electrical conductivity and a light-blocking property is placed in the approximately entire region sandwiched by the outer portion of the second substrate 1b and the frame-like portion of the front 2. The conductive layer 1e is formed on the surface of the second substrate 1b. The sheet 4 is connected to the inner surface of the frame-like portion of the front 2 and to the layer 1e at the outer portion of the second substrate 1b. Therefore, electric charges induced by electrification of the surface of the panel 1 are released to the front 2 by way of the sheet 4, leakage light generated by diffused reflection in the periphery of the panel 1 is surely blocked, and dust is surely prevented from entering the inside of the front 2 through the gap between the front 2 and the panel 1.

### Second Embodiment

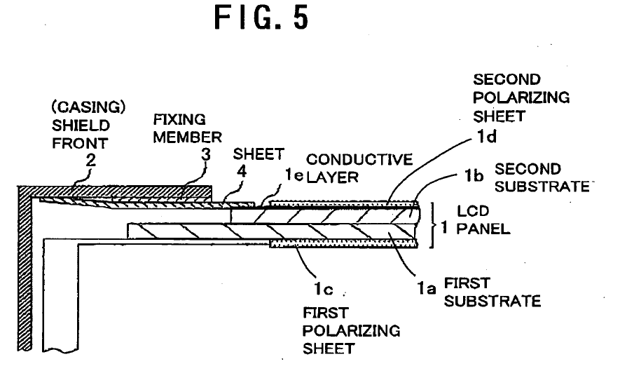

Next, an LCD device according to a second embodiment of the invention will be explained with reference to FIG. 5.

With the LCD device according to the above-described first embodiment, the shield front or casing 2 and the sheet 4 are electrically connected to each other with the conductive fixing member 3, as shown in FIG. 3. However, this structure may be modified as shown in FIG. 5.

In FIG. 5, the sheet 4 is fixed to the inner surface of the frame-like portion of the front 2 with the fixing member 3, like the first embodiment. However, unlike this, the outer end portion of the sheet 4 is bent toward the front 2, thereby directly contacting the sheet 4 with the front 2. In this case, electrical conductivity is not required for the member 3 and therefore, the selection range of material for the member 3 is expanded. As a result, there is an additional advantage that the fixing strength of the member 3 is increased and the usable temperature range is improved.

### Third Embodiment

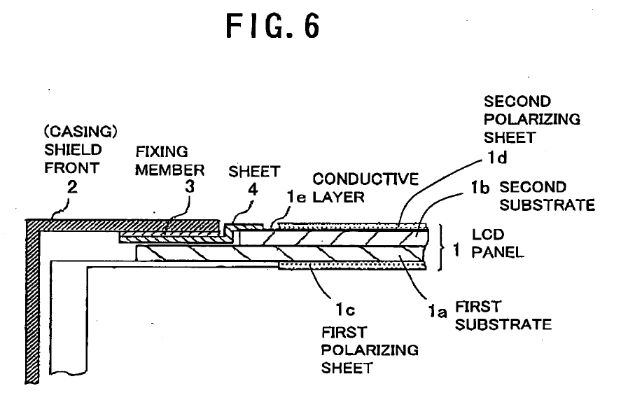

FIG. 6 shows an LCD device according to a third embodiment of the invention.

With the LCD device according to the above-described first embodiment, the sheet 4 is flat, as shown in FIG. 3. However, the shape of the sheet 4 may be modified as shown in FIG. 6.

Since the window of the front 2 is greater than the outer dimension of the second substrate 1b, there is no possibility that the front 2 contacts the panel 1, even if the distance between the front 2 and the panel 1 is reduced. Therefore, in this embodiment, the sheet 4 has a cross-section with two bends to form a stepwise structure, as shown in FIG. 6. When the LCD device is placed in such a way that the window of the front 2 is located at a top position, a first part of the sheet 4 on the frame-like portion of the front 2 is lower than a second part of the sheet 4 on the outer portion of the second substrate 1b. The inner surface of the frame-like portion of the front 2 is approximately equal to or lower than in height or level the surf ace of the second substrate 1b on the side of the window.

In the device of the third embodiment, there is an additional advantage that an LCD device having a reduced thickness can be fabricated.

### Fourth Embodiment

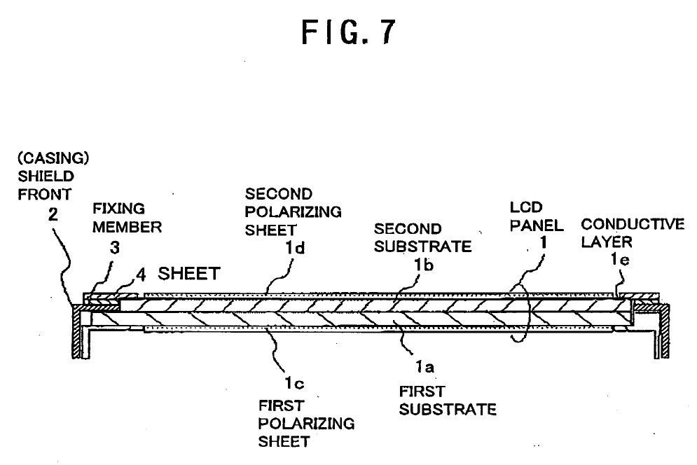

FIG. 7 shows an LCD device according to a fourth embodiment of the invention.

With the LCD devices according to the above-described first to third embodiments, the sheet 4 is adhered to the inner surface of the frame-like portion of the front 2 with the fixing member 3, as shown in FIGS. 3, 5, and 6. However, this structure may be modified as shown in FIG. 7.

In FIG. 7, the sheet 4 is adhered to the outer surface of the frame-like portion of the front 2 with the member 3. In this case, when the LCD device is placed in such a way that the window of the front 2 is located at a top position, the outer surface of the frame-like portion of the front 2 can be lower in height or level than the surface of the second substrate 1b on the side of the window.

In the device of the fourth embodiment, there is an additional advantage that an LCD device having a less thickness than the device of FIG. 6 can be fabricated.

### Fifth Embodiment

FIG. 9 shows an LCD device according to a fifth embodiment of the invention.

With the LCD devices according to the above-described first to fourth embodiments, the conductive layer 1e is formed on the surface of the second substrate 1b, as shown in FIGS. 3, 5, 6, and 7. However, this structure may be modified as shown in FIG. 9.

In FIG. 9, the conductive layer 1e is formed on the surface of the second polarizing sheet 1d, not the surface of the second substrate 1b. The sheet 4 is adhered onto the inner surface of the frame-like portion of the shield front 2 with the fixing member 3 in such a way as to cover the outer portion or peripheral area of the second polarizing sheet 1d and contacts the same. In this embodiment, the shape of the sheet 4 is similar to that of FIG. 6. However, the shape of the sheet 4 may be similar to that of FIG. 3, 5, or 7.

### Other Embodiments

It is needless to say that the present invention is not limited to the above-described embodiments and their variations. Any other modification is applicable to these embodiments.

For example, with the above-described first to fifth embodiments of the invention and their variations, the LCD device is of the transmissive type, where the backlight unit is located on the side of the first substrate 1a. However, the invention is not limited to this. The invention may be applied to the LCD device of any other type, such as the reflection type or the semi-transmissive type.

Moreover, the shield front or casing 2 has a U-shaped cross section and the front 2 is covered to the panel 1 from the side of the second substrate 1b in the above-described embodiments. However, it is sufficient for the invention that the front 2 has a window or opening on the side of the second substrate 1b. The structures of the front 2 on the opposite side to the window and those on the both end portions are not limited. Similarly, the assembly orientation of the front 2 to the panel 1 is not limited.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. An LCD device comprising:
an LCD panel having by a first transparent substrate, a second transparent substrate, and a liquid-crystal composite sandwiched by the first and second substrates; and
a casing for receiving the panel, the casing having a window on a side of the second substrate;
wherein the window of the casing is formed to be larger than an outer dimension of the second substrate;
a sheet having electrical conductivity and a light-blocking property is placed in an approximately entire region sandwiched by an outer portion of the second substrate and a frame-like portion of the casing that surrounds the window;
an electrically conductive layer is formed directly on or indirectly by way of an optical member on a surface of the second substrate, the surface being located on a side of the window; and
the sheet is connected to an inner surface of the frame-like portion of the casing and to the layer at the outer portion of the second substrate or on the member.

2. The device according to claim 1, wherein the sheet has a cross-section with at least one bend;
and wherein when the LCD device is placed in such a way that the window of the casing is located at a top position, a first part of the sheet on the frame-like portion of the casing is lower than a second part of the sheet on the outer portion of the second substrate or on the member; and
the inner surface of the frame-like portion of the casing is approximately equal to or lower than in height a surface of the second substrate or on the member on the side of the window.

3. The device according to claim 1, wherein the sheet is connected to the frame-like portion of the casing with an electrically conductive fixing member.

4. The device according to claim 1, wherein an end portion of the sheet on a side of the casing is bent toward the frame-like portion of the casing;
and wherein the sheet is fixed to the frame-like portion with a fixing member and contacted with the frame-like portion at the end portion.

5. The device according to claim 1, wherein the sheet has a picture-frame-shaped contour.

6. The device according to claim 1, wherein the sheet is formed by a combination of L-shaped, U-shaped, or I-shaped parts.

7. The device according to claim 1, wherein the sheet is made of polyethylene telephthalate resin, nylon resin, or vinyl chloride resin, into which an electrically conductive material or ingredient is mixed.

8. The device according to claim 1, wherein the sheet is made of stainless steel.

9. An LCD device comprising:
an LCD panel having by a first transparent substrate, a second transparent substrate, and a liquid-crystal composite sandwiched by the first and second substrates; and
a casing for receiving the panel, the casing having a window on a side of the second substrate;
wherein the window of the casing is formed to be larger than an outer dimension of the second substrate;
a sheet having electrical conductivity and a light-blocking property is placed in an approximately entire region sandwiched by an outer portion of the second substrate and a frame-like portion of the casing that surrounds the window;
an electrically conductive layer is formed directly on or indirectly by way of an optical member on a surface of the second substrate, the surface being located on a side of the window; and
the sheet is connected to an outer surface of the frame-like portion of the casing and to the layer at the outer portion of the second substrate or on the member.

10. The device according to claim 9, wherein when the LCD device is placed in such a way that the window of the casing is located at a top position, the outer surface of the frame-like portion of the casing is lower in height than a surface of the second substrate or on the member on the side of the window.

11. The device according to claim 9, wherein the sheet is connected to the frame-like portion of the casing with an electrically conductive fixing member.

12. The device according to claim 9, wherein an end portion of the sheet on a side of the casing is bent toward the frame-like portion of the casing;
and wherein the sheet is fixed to the frame-like portion with a fixing member and contacted with the frame-like portion at the end portion.

13. The device according to claim 9, therein the sheet has a picture-frame-shaped contour.

14. The device according to claim 9, wherein the sheet is formed by a combination of L-shaped, U-shaped, or I-shaped parts.

15. The device according to claim 9, wherein the sheet is made of polyethylene telephthalate resin, nylon resin, or vinyl chloride resin, into which an electrically conductive material or ingredient is mixed.

16. The device according to claim 9, wherein the sheet is made of stainless steel.
